(19) United States
(12) Patent Application Publication
(10) Pub. No.: US 2021/0145674 A1
(43) Pub. Date: May 20, 2021

(54) APPARATUS AND METHOD FOR ASSISTING A PATIENT FROM SITTING TO STANDING POSITION

(71) Applicant: THANH DIEP CONG TU, HO CHI MINH (VN)

(72) Inventor: THANH DIEP CONG TU, HO CHI MINH (VN)

(73) Assignee: TON DUC THANG UNIVERSITY

(21) Appl. No.: 14/918,590

(22) Filed: Oct. 21, 2015

(51) Int. Cl. A61G 5/14; A61G 5/12; A61G 5/04; A61G 5/08

(52) U.S. Cl. CPC A61G 5/14; A61G 5/0858; A61G 5/045; A61G 5/124

(57) ABSTRACT

A method and apparatus for assisting a patient from a sitting to standing position is disclosed, which includes: a base having caster wheels; a double scissors truss; a first motor operable to cause the double scissor truss to extend/retract vertically from the base; a first middle frame connected to the double scissor truss; a second middle frame hingedly connected to the front side of the first middle frame and is configured to be raised at an angle with the first middle frame; a seat member having a curved protrusion configured to assist the patient.

### FIELD OF THE INVENTION

The present invention relates generally to the field of medical devices. More specifically, the present invention relates to an apparatus that assists a patient from a sitting to standing position.

### BACKGROUND ART

Whether at home or in a hospital, patients or elderlies often need to be assisted in changing from sitting position to standing position and vice versa. It is difficult if not impossible for post-surgery patients or elderlies to sit down or stand up by themselves because these patients have atrophied leg muscles. Once in a standing position, a patient can either walk by herself or use a parallel bar to exercise her legs.

Traditionally, conventional patient lift assist seat do not include enough functions to adapt to different situations when a patient needs assistance to stand up or sit down by herself. In one conventional lift assist seat, the horizontal bars are not sufficient to support the heavy weight of a patient. This result in the lacking of angle to prop the patient to her fully standing position.

Yet in another conventional patient lift assist such as Huang's patient lift assist described in the U.S. patent application publication No. US-2011/0084529, Huang's lift assist seat suffers from the following limitations: First, when the patient in the sitting position by herself and in need of assistance to stand up, Huang's lift assist seat cannot be used because there is no way the patient can walk toward Huang's lift assist seat for assistance unless an assistant is close by to provide help.

Second, even when the device is near a patient who is in a standing position, there is difficulty in adjusting the device to the patient's position since the patient cannot bend down to move the device to the most precise location. In other words, Huang's lift assist seat lacks mobility and adjustability in order to adapt dynamically to a patient's situation.

Third, the cushion in Huang's lift assist seat is not conducive to assist the patient in moving out and moving in of the device. This is especially true when the patient is having difficulties in moving around.

Finally, Huang's lift assist seat suffers similar problem as the conventional lift assist seat in that it does not have sufficient layers and power to adapt to patient with different heights or weights.

Therefore what is needed is an apparatus patient sit to stand that can overcome the above described problems.

### SUMMARY OF THE INVENTION

Accordingly, an objective of the present invention is to provide an automatic patient lift which provides solutions to the problems described above. Thus, a method and apparatus for assisting a patient from a sitting to standing position is disclosed, which includes: a base having caster wheels; a double scissors truss; a first motor operable to cause the double scissor truss to extend/retract vertically from the base; a first middle frame connected to the double scissor truss; a second middle frame hingedly connected to the front side of the first middle frame and is configured to be raised at an angle with the first middle frame; a seat member having a curved protrusion configured to assist the patient.

These and other advantages of the present invention will no doubt become obvious to those of ordinary skill in the art after having read the following detailed description of the preferred embodiments, which are illustrated in the various drawing Figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a diagram illustrating a lift to stand assist apparatus (“apparatus”) in a fully folded position (rest or initial position) in accordance with an embodiment of the present invention;

FIG. 2 is a diagram illustrating the apparatus of FIG. 1 when a double scissor truss is extended by a first motor in accordance with an embodiment of the present invention;

FIG. 3 is a diagram illustrating the apparatus of FIG. 1 when a first middle frame is extended by a fourth motor in accordance with an embodiment of the present invention;

FIG. 4 is a diagram illustrating the apparatus of FIG. 1 when a seat assembly is extended by a fifth motor in accordance with an embodiment of the present invention;

FIG. 5. is a diagram illustrating the apparatus of FIG. 1 with the second middle frame and the seat assembly removed in accordance with an embodiment of the present invention;

FIG. 6 is a diagram illustrating a different view of the apparatus of FIG. 1 with the second middle frame and seat assembly removed in accordance with an embodiment of the present invention;

FIG. 7 is a diagram illustrating the apparatus of FIG. 1 with the base and double scissor truss removed in accordance with an embodiment of the present invention;

FIG. 8 is a diagram illustrating a lateral view of the apparatus as described in FIG. 7 in accordance with an embodiment of the present invention;

FIG. 9 is a diagram illustrating a patient using the apparatus of FIG. 1 in accordance with an embodiment of the present invention; and

FIG. 10A is a diagram illustrating the remote control for controlling the apparatus of FIG. 1 in accordance with an embodiment of the present invention.

FIG. 10B is a block diagram of the electrical component of the remote control of FIG. 10A in accordance with an embodiment of the present invention.

FIG. 11 is a block diagram illustrating different components controlled by the controller in accordance with an embodiment of the present invention.

FIG. 12 is a flow chart illustrating a method for controlling the apparatus of FIG. 1 in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

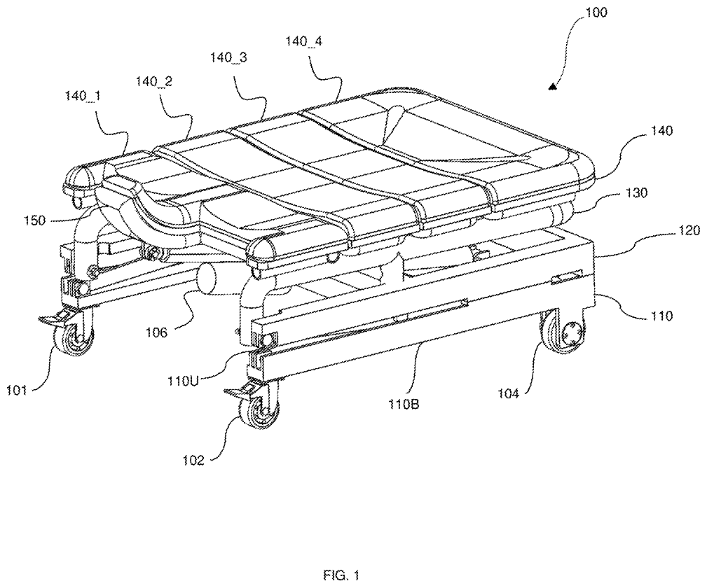

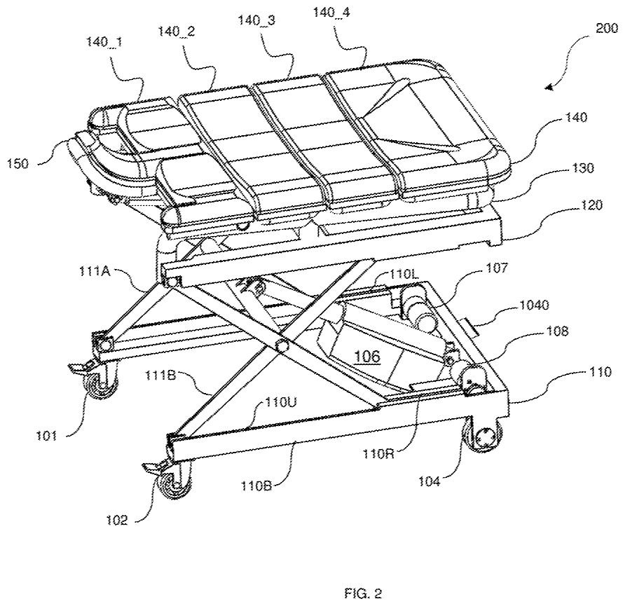

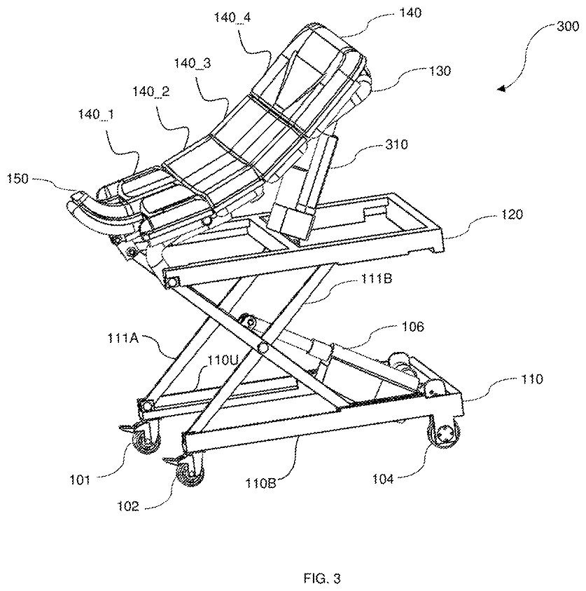

One embodiment of the invention is now described with reference to FIGS. 1 to 3. FIG. 1 shows an embodiment of an apparatus for assisting a patient from a sitting to a standing position 100 (hereinafter referred to as ‘apparatus 100’). Apparatus 100 includes a base 110 having an upper side 110U and a bottom side 110B. On the bottom side 110B, base 110 is mounted on a first wheel 101, a second wheel 102, a third wheel 103 (not seen in FIG. 1, please refer to FIG. 2), and a fourth wheel 104 (not seen in FIG. 1; see FIG. 3). First wheel 101 and second wheel 102 are connected to the front side of base 110 while third wheel 103 and fourth wheel are connected to the backside of base 110. On upper side 110U, base 110 is mechanically connected to a first middle frame 120, a second middle frame 130, and a seat member 140. In one embodiment, seat member 140 is comprised a first segment 140_1, a second segment 140_2, a third segment 140_3, and a fourth segment 140_4. These segments 140_1-140_4 are flexibly connected together so that seat member 140 is concaved down when raised up from the back side or when a patient sits thereon. In one embodiment, a curved element 150 is protruded from the front center of seat member 140. Curved member 150 functions to prevent a patient from accidentally falling off when seat member 140 is raised from the back side. Together, curved element 150 and segments 140_1-1404 provide complete assistance, stability, and comfort to the patient.

Referring next to FIG. 2 which illustrates a second operational stage 200 of apparatus 100 as described in FIG. 1. As shown in second operational stage 200, apparatus 100 also includes a double scissor truss 111 connected to upper side 110U of base 110. A first motor 106 is connected to the back side of base 110 and to the mid-section of double scissor truss 111. FIG. 2 also shows a second motor connected to third wheel 103 while a third motor 108 connected to fourth wheel 104. In one embodiment, a controller 210 for controlling first motor 106, second motor 107, and third motor 108 is positioned in the back side of base 110. Please note that controller 210 can be positioned anywhere on apparatus 100 is within the scope of the present invention.

Continuing with FIG. 2, operational position 200 of apparatus 100 also illustrates that double scissor truss 111 includes a pair of X-shaped frames 111a and 111b that are hingedly connected at the center by a horizontal bar 111c. First motor 106 is connected to horizontal bar 111c and the backside of base 110. The front leg of first X-shaped frame 111a is connected to upper side 110U of base 110 above first wheel 101. Similarly, the front leg of second X-shaped frame 111b is connected to upper side 110U of base 110 above second wheel 102. The rear leg of first X-shaped frame 111a is connected to slide in and out of a first track 110R. The rear leg of second X-shaped frame 111b is connected to slide in and out of a second track 110L. When double scissor truss 111 is retracted, the rear legs of first X-shaped frame 111a and second X shaped frame 111b are slid into first track 110R and second track 110L respectively. Double scissor truss 111 is completely collapsed and stored within base 110 as shown in FIG. 1. On the other hand, when double scissor truss 111 is fully extended, rear legs of first X-shaped frame 111a and second X-shaped frame 111b are slid out of first track 110R and second track 110L. Double scissor truss 111 is fully erected as shown in FIG. 2.

Now referring to FIG. 3 which illustrates a third operational stage 300 of apparatus 100. As shown in operational stage 300, apparatus 100 also includes a fourth motor 310 connected between first middle frame 120 and second middle frame 130. In one embodiment, second middle frame 120 is a rectangular A-shaped frame. Fourth motor 310 is connected between the middle horizontal bar of the rectangular A-shaped frame to the rear end of second middle frame 130. In third operational stage 300, double scissor truss 111 is fully extended to expose first motor 106 and base 110. Fourth motor 310 is in the extent state to expose first middle frame 120.

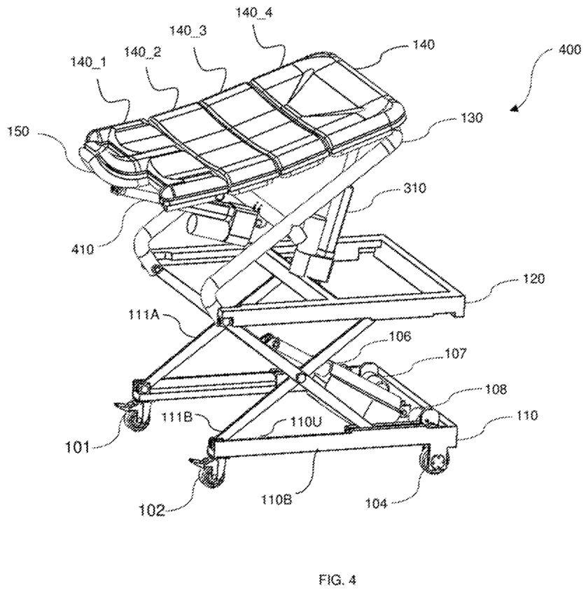

Referring next to FIG. 4 which illustrates a fourth operational stage 400 of apparatus 100 where seat assembly 140 is fully extended. More particularly, in fourth operational stage 400, apparatus 100 is shown to include a fifth motor 410. In one embodiment, second middle frame 130 is a rounded A-shaped frame. Fifth motor 410 is connected between the middle section of second middle frame 130 to the front side of seat assembly 140. Fourth operational stage 400 is also known as the stand-up position where all motors—first motor 106, second motor 107, third motor 108, fourth motor 310, and fifth motor 410 are fully extended. As a result, second middle frame 130 is formed an angle with first middle frame 120 which is parallel to base 110. Seat assembly 140 is also raised at an angle with respect to second middle frame 130.

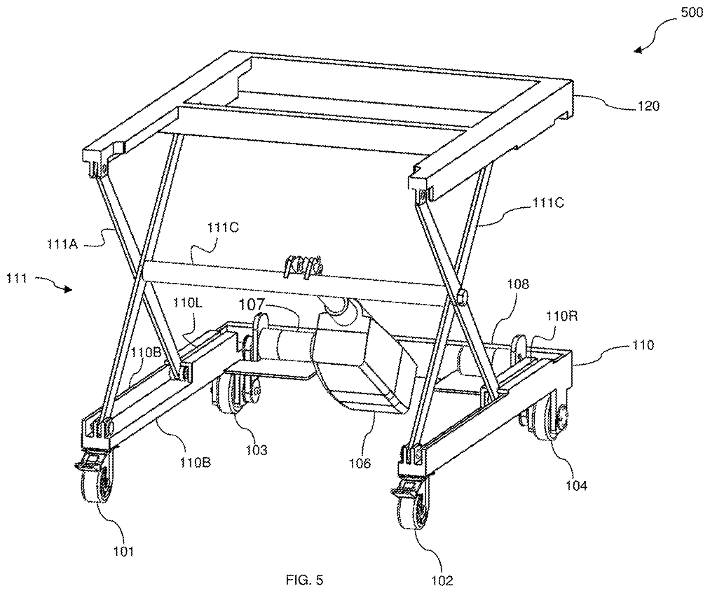

Now referring to FIG. 5 which illustrates the front view 400 of apparatus 100 in which second middle frame 130 and seat assembly 140 are removed. As such front view 400 shows the structures of base 110, double scissor truss 111, and first middle frame 120. More particularly, base 110 is a square C-shaped frame with the open end being the front side where first wheel 101 and second wheel 102 are connected. At the two corners of the back side of the square C-shaped frame, third wheel 103 is connected with second motor 107 and fourth wheel 104 is connected with third motor 108 respectively. Next to the two corners of the back side, first track 110R and a second track 110L are designed as shown to store double scissor truss 111.

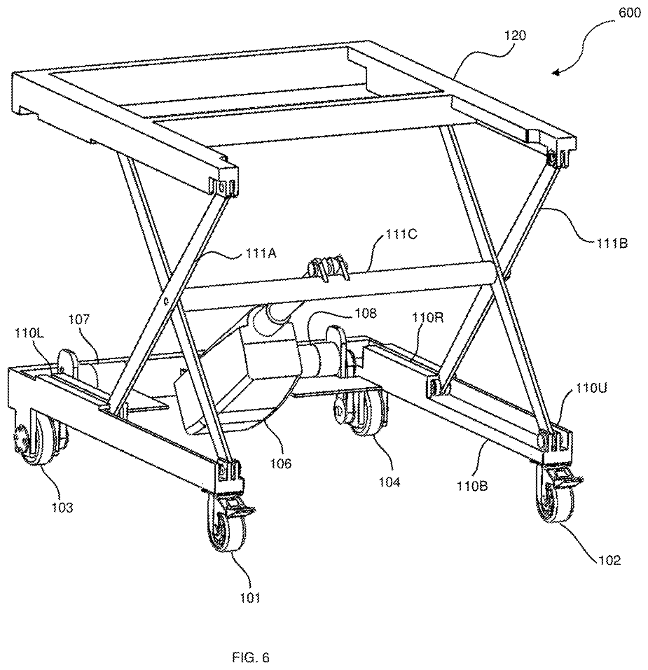

Now referring to FIG. 6, another perspective view 600 of apparatus 100 is illustrated. Third wheel 103 is coupled to second motor 107 and fourth wheel 104 is coupled to be controlled by third motor 108. In this embodiment, third wheel 103 and fourth wheel 104 are not caster wheels. By controlling second motor 107 and third motor 108, apparatus 100 can turn either left or right.

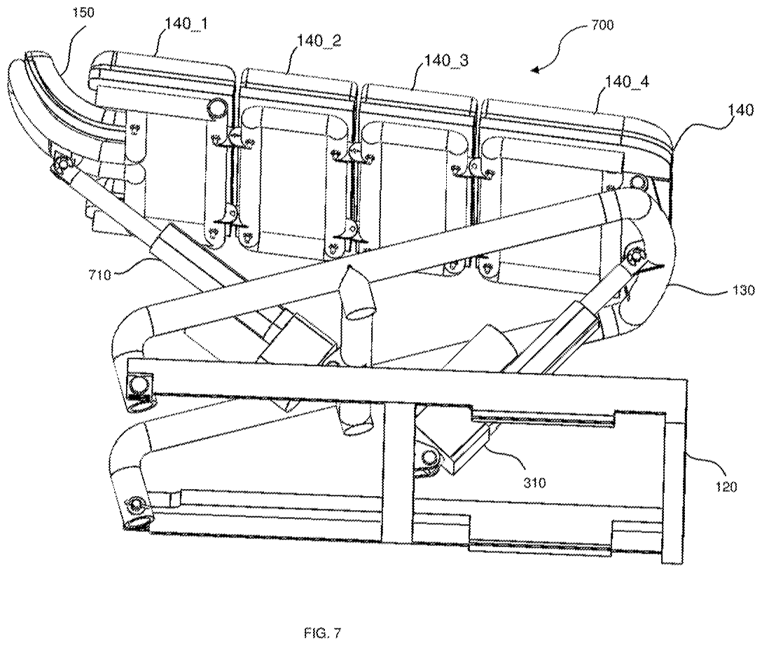

Referring next to FIG. 7, a perspective view 700 from the bottom of first middle frame 120, second middle frame 130, and seat assembly 140 is illustrated.

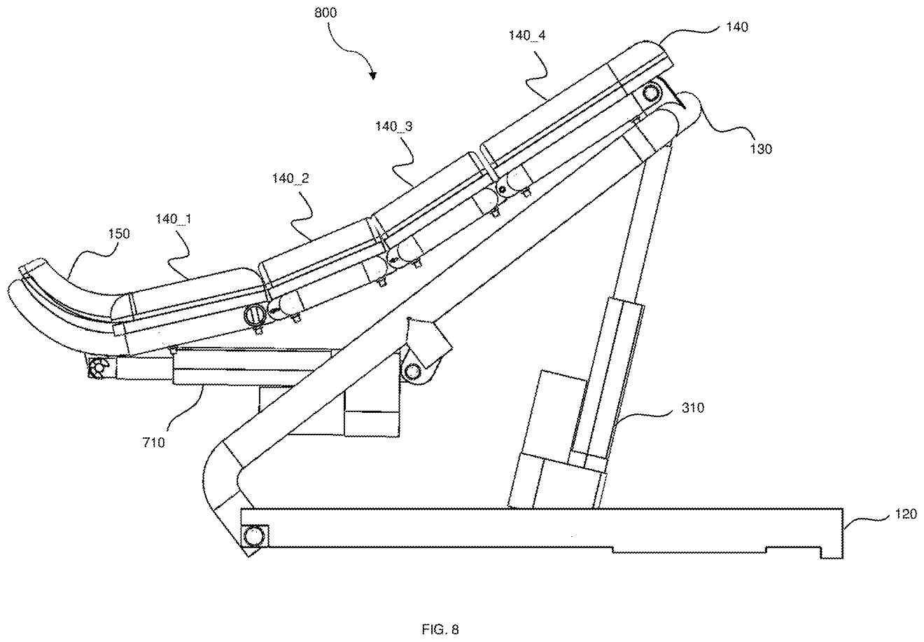

Similarly, FIG. 8 illustrates a side perspective 800 of first middle frame 120, second middle frame 130, and seat assembly 140.

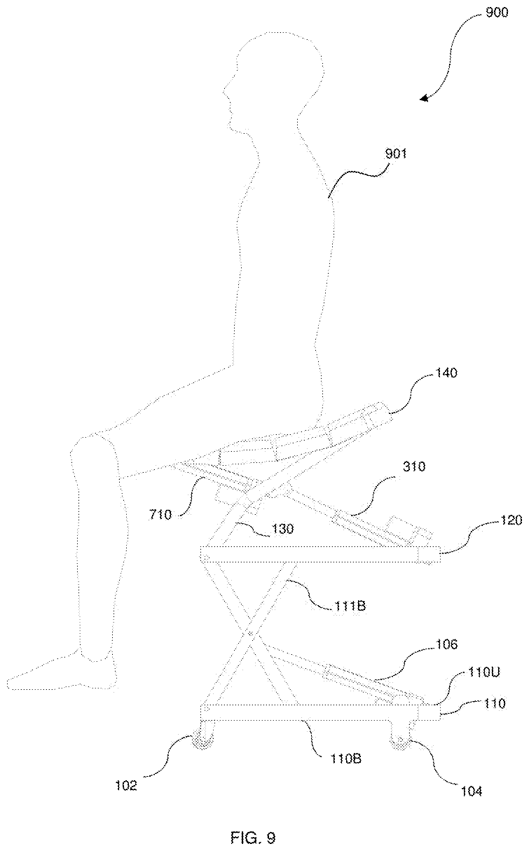

Referring next to FIG. 9 which illustrates a perspective view 900 in which a patient 901 is being assisted by apparatus 100 to stand up.

In one embodiment, apparatus 1000 has a length of 730 mm, a width of 450 mm, and a height of 350 mm when fully folded. When fully extended to assist patient 901 to stand up, apparatus 100 a length of 730 mm, a width of 450 mm, and a height of 790 mm. When extended in the sitting position (double scissor truss 111 is fully extended), apparatus 100 has a length of 730 mm, a width of 450 mm, and a height of 470 mm. First motor 106, fourth motor 310, and fifth motor 710 are a HIWIN LAS 2 motor which receives a DC 24 volts DC power, maximum current 3 amps, maximum push power of 1800 N, maximum pull power 1200 N, maximum speed of 7 mm/second, maximum length of 345 mm and minimum length of 245 mm. First motor 106 receives a 24 volts input voltage supply, has a maximum thrush power of 3500 N and extends to a maximum length of 150 mm. Finally, second motor 107 and third motor 108 is a TG-85C-SG motor which has an output power of 6 watts, 1/36, and rotate at 125 rounds per minute.

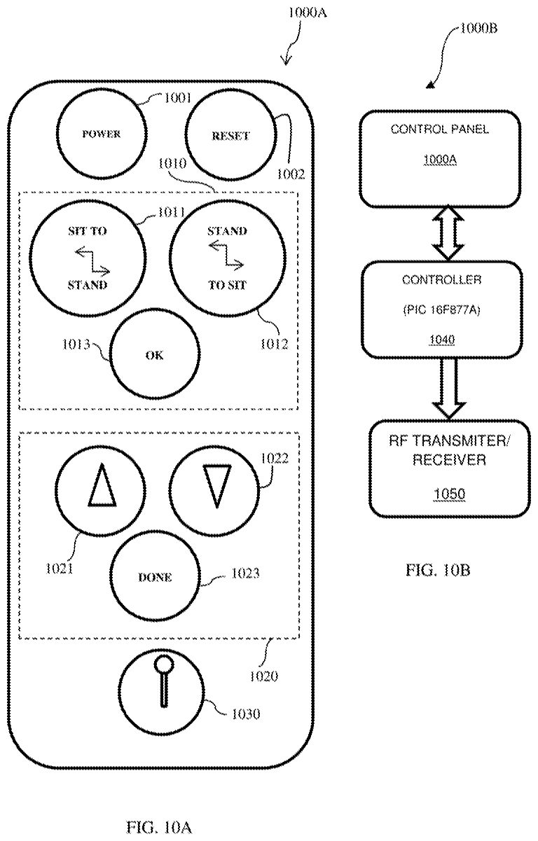

Now referring to FIG. 10A, a remote control 1000A used with apparatus 100 is illustrated. In one embodiment, remote control 1000A has a power button 1001 for turning on or off the power supply. A reset button 1002 causes apparatus 100 to go to the fully folded position (or the initial position) as shown in FIG. 1. For example, if patient 901 observes apparatus 100 is not fully extended to the standing position as illustrated in the operation stage 200 in FIG. 2, patient 901 can press reset button 1002 to bring apparatus 100 to the initial fully folded position. Next, a fully automatic mode section 1010 includes a sit to stand button 1011, a stand to sit button 1012, and an OK button 1013. Automatic mode section 1010 is designed for the fully automatic mode of apparatus 100. If patient 901 presses sit to stand button 1011, apparatus 100 automatically goes through different operational stages from sitting to standing as discussed in FIG. 1-FIG. 4. On the other hand, stand to sit button 1012 causes apparatus 100 to go from standing to sitting position. OK button 1013 causes apparatus 100 to stay at the current operational stage as shown in FIG. 1 to FIG. 4.

Continuing with FIG. 10A, a manual section 1020 is designed for patient 901 to manually control apparatus 100. An “Up” button 1021 causes apparatus 100 to extend into the fully standing position 400 as shown in FIG. 4. A “Done” button 1023 is used to stop apparatus 100 at any stage. If patient 901 wants to stop apparatus 100 at any operational stage illustrated in FIG. 1-FIG. 4, he or she presses “Done” button 1023. Similarly, a “Down” button 1022 causes apparatus 100 to go back to the initial rest (fully folded) position as shown in FIG. 1. Finally, a joy stick 1030 is designed for patient 901 to drive apparatus 100 including going straight, going backward, turning left, or turning right using second motor 107 and third motor 108. To stop apparatus 100, patient 901 simply releases joy stick 1030 into the default or initial position.

Next, referring to FIG. 10B illustrating a block diagram of an electrical system 1000B that controls apparatus 100. Remote control 1000A is connected to a controller 1040 and to a RF transmitter/receiver 1050. In one embodiment, controller 1040 is a PIC 16F877A controller. Since electrical system 1000B is well known in the art, it will not be discussed in details here.

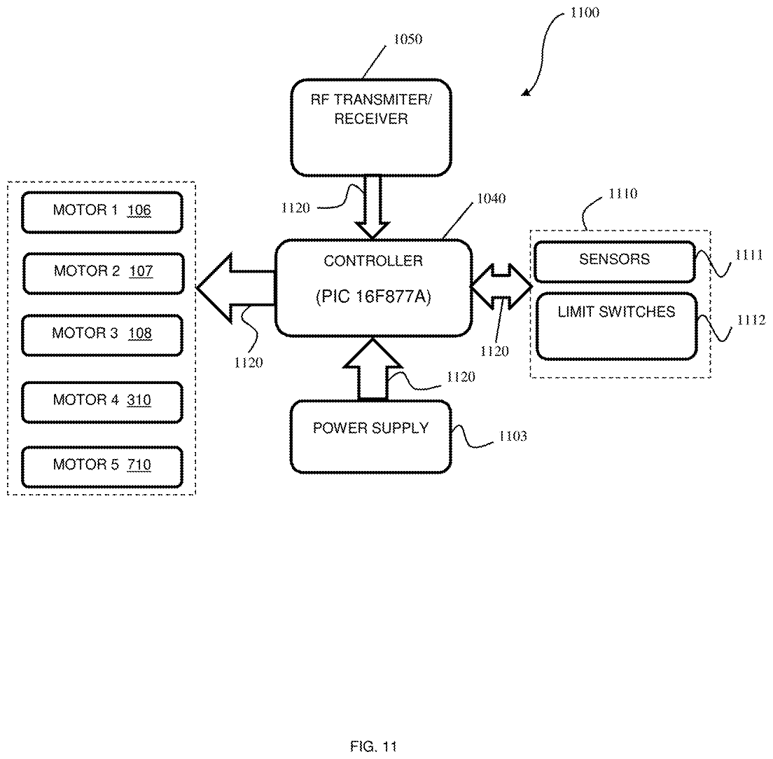

Next referring to FIG. 11 which illustrates a complete block diagram of the electrical control for apparatus 100. Controller 1040 controls first motor 106, second motor 107, third motor 108, fourth motor 310, and fifth motor 710 via communication channel 1120. In one embodiment, communication channel 1120 is wireless using radio frequencies. Controller 1040 has a power supply 1103 and RF transmitter/receiver 1050. In one embodiment, controller 1040 also includes a limiting device 1110. Limiting device 1110 is used to prevent apparatus 100 from operating beyond its range. Limiting device 1110 includes sensors 1111 designed to sense different operational stages 200-400 of apparatus 100 as discussed in FIG. 1-FIG. 4 above. If apparatus 100 is accidentally forced by patient 901 to operate beyond the specifications of each motor, limit switches 1112 informs controller 1040 to stop motors 106, 107, 108, 310, and 710. In one embodiment, sensors 1111 and limit switches 1112 are designed to prevent apparatus 1000 from falling a cliff. Sensors 1111 and limit switches 1112 also stop apparatus 100 when it reaches a wall or is stuck in a corner.

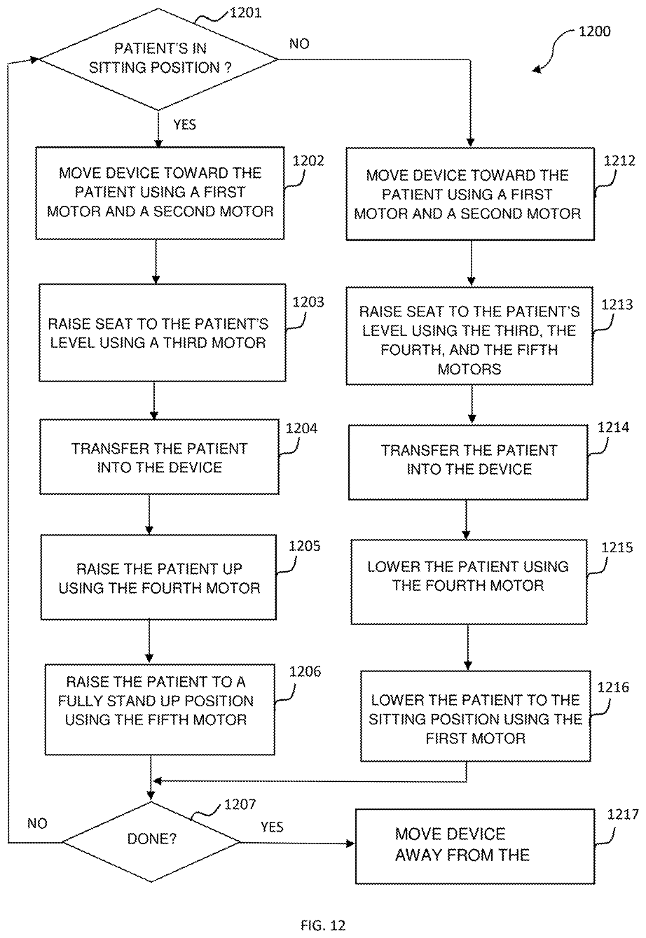

Now referring to FIG. 12, a method 1200 for operating apparatus 100 is illustrated. Basically, controller 1040 is programmed to control first motor 106, second motor 107, third motor 108, fourth motor 310, and fifth motor 710 in accordance with the present invention. In one embodiment, method 1200 is a computer program stored in a non-transitory computer readable media such as Read-Only-Memory (ROM), Random Access Memory (RAM), etc.

At step 1201, a patient is determined whether he or she is in a sitting position or a standing position. In one embodiment, step 1201 is performed by pressing sit to stand button 1011 or stand to sit button 1012.

At step 1202, if the patient is in a sitting position, apparatus 100 is moved toward the patient. Step 1202 is performed by controlling second motor 107 and third motor 108 using remote control 1000A. Apparatus 100 is turned left or turned right by applying different powers (rotations) to second motor 107 connected to third wheel 103 and third motor 108 connected to fourth wheel 104. As such, first caster wheel 101 and second caster wheel 102 are caused to turn accordingly. In one embodiment, Step 1202 is realized by using joy stick 1030 to move apparatus 100 forward, backward, turn left, turn right to the patient's location.

At step 1203, a seat assembly is raised using a motor to meet the sitting level of the patient so that the patient is transferred over from his or her current location. Step 1203 is realized by first motor 106 resulting in operational stage 200 is illustrated and discussed in FIG. 2.

At step 1204, as discussed above in step 1203, the patient is transferred over to apparatus 100 from his or her sitting position.

At step 1205, a patient is raised up to a next height using a fourth motor. Since the patient cannot stand by himself or herself due to the injuries, step 1205 is designed to help the patient to slowly stand up. Step 1205 is realized by fourth motor 310 resulting in operational stage 300 is illustrated and discussed in FIG. 3.

Next at step 1206, a patient is raised to a fully standing position using a fifth motor. Step 1206 is realized by fifth motor 710 resulting in operational stage 400 illustrated and discussed in FIG. 4.

Next, at step 1207, determine whether the patient needs the assistance of the sit to stand apparatus. Step 1207 is realized by pressing either “Done” button 1023 in the manual mode 1020 or OK button 1013 in automatic mode 1010.

At step 1217, after the completion command is received, apparatus is moved away from the patient. Step 1217 is performed by second motor 107 or third motor 108. In one embodiment, step 1217 is performed by using joy stick 1030.

At step 1218, if the patient needs to exercise, steps 1201-1207 are repeated.

At step 1212, if the patient is in a standing position, apparatus 100 is moved toward the patient. Step 1212 is performed by controlling second motor 107 and third motor 108 using remote control 1000A. Apparatus 100 is turned left or turned right by applying different powers (rotations) to second motor 107 connected to third wheel 103 and third motor 108 connected to fourth wheel 104. As such, first caster wheel 101 and second caster wheel 102 are caused to turn accordingly. In one embodiment, Step 1212 is realized by using joy stick 1030 to move apparatus 100 forward, backward, turn left, turn right to the patient's location.

At step 1213, a seat assembly is raised using motors to meet the sitting level of the patient so that the patient is transferred over from his or her current location. Step 1213 is realized by first motor 106, fourth motor 310, and fifth motor 710 resulting in operational stage 400 is illustrated and discussed in FIG. 4.

At step 1214, as discussed above in step 1213, the patient is transferred over to apparatus 100 from the standing position.

At step 1215, a patient is lowered to a lower height using a fifth motor. Since the patient cannot sit down by himself or herself due to the injuries, step 1215 is designed to help the patient to slowly stand up. Step 1215 is realized by fourth motor 310 resulting in operational stage 200 is illustrated and discussed in FIG. 2.

Next at step 1216, a patient is further lowered to a rest position using a first motor. Step 1216 is realized by first motor 106 resulting in the rest position illustrated and discussed in FIG. 1.

Finally steps 1217 and 1218 are performed as discussed above.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. An apparatus for assisting a patient from a sitting to standing position, comprising:
a base having a first caster wheel, a second caster wheel, a third wheel, and a fourth wheel, wherein said first caster wheel, said second caster wheel, said third and said fourth wheels are arranged from front to back at four corners of a bottom side of said base respectively;
a double scissors truss, mechanically connected on a top side of said base, operable to extend and retract vertically from said base;
a first motor connected to the back side of said base and said double scissor truss, operable to cause said double scissor truss to extend or retract vertically from said base;
a first middle frame connected to the top portion of said double scissor truss, said middle frame having a front side and a back side;
a second middle frame hingedly connected to the front side of said first middle frame so that said second middle frame is configured to raise from its backside, forming an angle with said first middle frame;
a second motor coupled to said third wheel, operable to cause said third wheel to move;
a third motor coupled to said fourth wheel, operable to cause said fourth wheel to rotate;
a fourth motor, connected between the middle portion of said first middle frame to the back of said second middle frame so that said fourth motor is operable to raise the backside of said second middle frame;
a seat member, connected only to the back side of said second middle frame;
a fifth motor, connected to the backside of said seat member and a middle portion of said second middle frame, operable to cause said seat member to lift from the front side of said seat member while the back side of said seat member is hingedly connected to the back side of said second middle frame;
a controller, electrically connected to to control the operations of said first motor, said second motor, said third motor, said fourth motor, and said fifth motor; and
a curved protrusion connected to the middle of said seat member operable to prevent a user from falling out of said seat member.

2. The apparatus of claim 1 wherein said seat member further comprises four different segments flexibly connected together so that said seat member is curved downward to said base when said seat member is elevated by said third motor.

3. The apparatus of claim 1 wherein said base further comprises a first track and a second track where said scissor truss is configured to slide in and out to extend or retract from said base.

4. The apparatus of claim 4 wherein said second motor and third motor each has an output power of 6 watts, 1/36, and rotate at 125 rounds per minute.

5. The apparatus of claim 4 wherein said first motor, said fourth motor, and said fifth motor each receives a DC 24 volts DC power, maximum current 3 amps, maximum push power of 1800 N, maximum pull power 1200 N, maximum speed of 7 mm/second, maximum length of 345 mm and minimum length of 245 mm.

6. The apparatus of claim 1 when fully folded has a length of 730 mm, a width of 450 mm, and a height of 350 mm.

7. The apparatus of claim 1 when extended in the sitting position has a length of 730 mm, a width of 450 mm, and a height of 470 mm.

8. The apparatus of claim 1 when fully extended out in the standing position has a length of 730 mm, a width of 450 mm, and a height of 790 mm.

9. The apparatus of claim 5 wherein said controller is configured to change said apparatus from fully folded position, sitting position, and standing position.

10. The apparatus of claim 1 wherein said first middle frame and a second middle frame has a rectangular A shape.

11. The apparatus of claim 10 wherein the two legs of said first middle frame and said second middle frame are hingedly connected together.

12. The apparatus of claim 11 wherein said fourth motor is connected to the middle bar of said first middle frame and to the top of said second middle frame.

13. The apparatus of claim 10 wherein said fifth motor is connected to the middle bar of said second middle frame to said curved protrusion of said seat member.

14. A method of using a sit to stand apparatus including a base, a first middle section, a second middle section, and a seat section, wherein said base includes a first caster wheel, a second caster wheel arranged in front of said base and a third wheel and a fourth wheel in the rear said of said base which are controlled by a second and a third motor respectively, comprising:
determining whether a patient is in a sitting or standing position;
if said patient is in the sitting position, moving said apparatus to said patient in need of assistance using said second motor and said third motor;
upon arrival at the patient's location, use a first motor to raise said seat section to the level of said patient;
transferring said user to said sit to stand apparatus;
using a fourth motor to lift said patient;
using a fifth motor to fully lift said patient to the standing position; and
moving said sit to stand device away from said patient.

15. The method of claim 14 further comprising the following steps:
if said patient is in a standing position, moving said apparatus to said patient in need of assistance using said second motor and said third motor;
upon arrival at the patient's location, use a first motor, a fourth motor, and a fifth motor to fully extend said sit to stand apparatus to the level of said patient;
transferring said user to said sit to stand apparatus; and
using said first motor to lower said seat section to the rest position;
using said fourth motor to lower said seat section and said second middle section;
using said fifth motor to lower to a sitting position; and
moving said patient to the final location; and
moving said sit to stand device away from said patient.

16. The method of claim 14 wherein said second motor and third motor each has an output power of 6 watts, 1/36, and rotate at 125 rounds per minute.

17. The method of claim 14 wherein said first motor, said fourth motor, and said fifth motor each receives a DC 24 volts DC power, maximum current 3 amps, maximum push power of 1800 N, maximum pull power 1200 N, maximum speed of 7 mm/second, maximum length of 345 mm and minimum length of 245 mm.

18. The method of claim 14, wherein said apparatus when fully folded has a length of 730 mm, a width of 450 mm, and a height of 350 mm.

19. The method of claim 14 wherein said apparatus when extended in the sitting position has a length of 730 mm, a width of 450 mm, and a height of 470 mm, and when fully extended out in the standing position has a length of 730 mm, a width of 450 mm, and a height of 790 mm.

20. The method of claim 15 further comprises resetting said first motor, said fourth motor, and said fifth motor to their initial positions when said patient does not need further assistance.
